(19) United States
(12) Patent Application Publication
(10) Pub. No.: US 2024/0037687 A1
(43) Pub. Date: Feb. 1, 2024

(54) LOTTERY DRAWING METHOD FOR MULTIPLE NFT PRIZES AND THE NFT LOTTERY SYSTEM THEREOF

(71) Applicant: Crypto Sweepstakes LLC, Oviedo, FL (US)

(72) Inventor: Christopher Todd Godwin, Oviedo, FL (US)

(21) Appl. No.: 18/227,431

(22) Filed: Jul. 28, 2023

Related U.S. Application Data
(60) Provisional application No. 63/393,720, filed on Jul. 29, 2022.

(51) Int. Cl. G06Q 50/34; G06Q 20/38; G06Q 20/36; G07F 17/32

(52) U.S. Cl. CPC G06Q 50/34; G06Q 20/389; G06Q 20/3678; G07F 17/329; G07F 17/3244

(57) ABSTRACT

The present invention provides a lottery drawing method for multiple NFT prizes and the NFT lottery system thereof. The NFT system comprising an ID generator, a comparing processor, and a notifying processor. The ID generator can randomly generate a first wallet ID, a first blockchain ID, a second wallet ID and a second blockchain ID. The comparing processor can compare the second wallet ID and the second blockchain ID with the first wallet ID and the first blockchain ID, to see if there is a win. The notifying processor can inform the user whether there is a win and what NFT prize is won. By using this lottery drawing method and the system, the user can quickly and simply carry out the NFT-based lottery game.

### FIELD OF THE INVENTION

The present invention relates generally to a lottery drawing method, and more particularly, the present invention discloses a lottery drawing method for multiple NFT prizes and the NFT lottery system thereof, which can take advantage of full digitization to allow quick and easy draws for every potential player. Moreover, through a special comparison method combined with NFT-based related prizes, each winner can have a good experience and be proud of the unique prizes they have won.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

There are more and more games related to the lottery on the Internet, yet, this type of on-line lottery game still has many shortcomings, such as the players being unable to supervise the lottery process, is not accurate or satisfactory, etc. Moreover, more and more players now care more about whether the prizes they get are indeed valuable.

Therefore, how to solve those problems and present a better on-line lottery game is the main goal that the applicant wants to achieve.

### SUMMARY

In order to solve the problem above, the present invention redefines the way of on-line lottery game, and combine it with the non-fungible tokens (NFTs).

In details, the present invention provides a lottery drawing method for multiple NFT prizes, comprising:
(A) randomly generating a first wallet ID and a first blockchain ID for a NFT prize game created in an NFT lottery system, wherein the NFT prize game contains at least one type of the NFT prizes, which is first tier NFT prizes;
(B) randomly generating a second wallet ID when a user creates a crypto wallet in the NFT lottery system;
(C) randomly generating a second blockchain ID when the user uses the crypto wallet to buy a NFT lottery ticket in the NFT lottery system;
(D) comparing the second wallet ID and the second blockchain ID with the first wallet IDs and the first blockchain IDs, then;
   (a) if the second wallet ID matches with last three digits or letters of the first wallet ID, and the second blockchain ID matches with last two digits or letters of the first blockchain ID, the user wins one of the first tier NFT prizes; or
   (b) if the second wallet ID doesn't match with last digit or letter of the first wallet ID, or the second blockchain ID doesn't match with last digit or letter of the first blockchain ID, the user wins nothing; and
(E) Sending matching result and corresponding NFT prize, if any, to the user.

In another aspect, the at least one type of the NFT prizes further comprises second tier NFT prizes and third tier NFT prizes, and the step (D) further comprises:
(c) if the second wallet ID matches with last digit or letter of the first wallet ID, and the second blockchain ID matches with last digit or letter of the first blockchain ID, the user wins one of the third tier NFT prizes; or
(d) if the second wallet ID matches with last two digits or letters of the first wallet ID, and the second blockchain ID matches with last two digits or letters of the first blockchain ID, the user wins one of the second tier NFT prizes.

In another aspect, wherein the first wallet ID and the second wallet ID have 40 digits respectively and begin with “0x”.

In another aspect, wherein the first blockchain ID and the second blockchain ID have 8 digits respectively.

In another aspect, wherein the first wallet ID and the first blockchain ID are stored in a secure database of the NFT lottery system.

In another aspect, wherein the third tier NFT prizes are NFT branded clothing.

In another aspect, wherein the second tier NFT prizes are watches and luxury brand merchandise.

In another aspect, wherein the first tier NFT prizes are at least one of the following: vacations, celebrity meet-ups, luxury cars and houses.

In another aspect, wherein odd of winning the third tier NFT prizes is between 1/340 and 1/11,560, and preferred odd is 1/340.

In another aspect, wherein odd of winning the second tier NFT prizes is between 1/115,600 and 1/3,930,400, and preferred odd is 1/115,600.

In another aspect, wherein odd of winning the first tier NFT prizes is between 1/11,560,000 to 1/13,363,360,000, and preferred odd is 1/11,560,000.

Furthermore, the present invention further provides a NFT lottery system, which uses a lottery drawing method mentioned above, comprising:
an ID generator, for randomly generating a first wallet ID, a first blockchain ID for an NFT prize game created in the NFT lottery system, and a second wallet ID and a second blockchain ID, wherein the NFT prize game contains at least one type of the NFT prizes, which is first tier NFT prizes;
a comparing processor, which is connected to the ID generator for comparing the second wallet ID and the second blockchain ID with the first wallet ID and the first blockchain ID, wherein:
   (a) if the second wallet ID matches with last three digits or letters of the first wallet ID, and the second blockchain ID matches with last two digits or letters of the first blockchain ID, the user wins one of the first tier NFT prizes; or
   (b) if the second wallet ID doesn't match with last digit or letter of the first wallet ID, or the second blockchain ID doesn't match with last digit or letter of the first blockchain ID, the user wins nothing; and
a notifying processor, which is connected to the comparing processor for informing the user whether there is a win and what NFT prize is won.

In another aspect, wherein the at least one type of the NFT prizes further comprises second tier NFT prizes and third tier NFT prizes, and the comparing processor further proceeds with:
(c) if the second wallet ID matches with last digit or letter of the first wallet ID, and the second blockchain ID matches with last digit or letter of the first blockchain ID, the user wins one of the third tier NFT prizes; or
(d) if the second wallet ID matches with last two digits or letters of the first wallet ID, and the second blockchain ID matches with last two digits or letters of the first blockchain ID, the user wins one of the second tier NFT prizes.

In another aspect, wherein the first wallet ID and the second wallet ID have 40 digits respectively and begin with “0x”.

In another aspect, wherein the first blockchain ID and the second blockchain ID have 8 digits respectively.

In another aspect, wherein the first wallet ID and the first blockchain ID are stored in a secure database of the NFT lottery system.

In another aspect, wherein the third tier NFT prizes are NFT branded clothing.

In another aspect, wherein the second tier NFT prizes are watches and luxury brand merchandise.

In another aspect, wherein the first tier NFT prizes are at least one of the following: vacations, celebrity meet-ups, luxury cars and houses.

In another aspect, wherein odd of winning the third tier NFT prizes is 1/340.

In another aspect, wherein odd of winning the second tier NFT prizes is 1/115600.

In another aspect, wherein odd of winning the first tier NFT prizes is 1/3930400.

In the present invention, by combining the on-line lottery game with the NFT mechanism, the on-line lottery game's mechanism can be made known to the players, and the accuracy of the system can be guaranteed while avoiding doubts from the players. And, the prizes are issued in the form of NFT, which is not only valuable, but also easier to satisfy players.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a block diagram of the lottery drawing method, in accordance with an embodiment of the present invention;

FIG. 2 illustrates a block diagram of NFT lottery system, in accordance with an embodiment of the present invention;

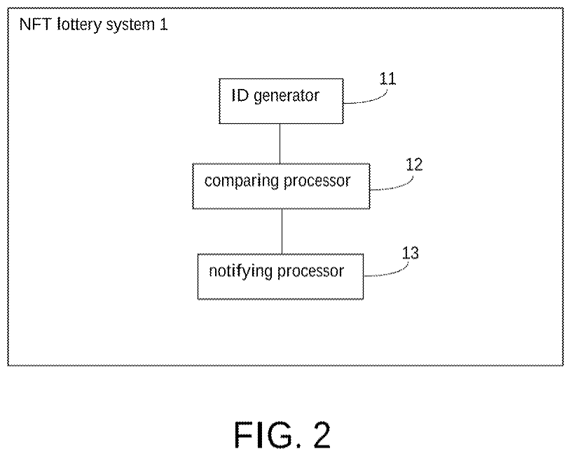

Like reference numerals refer to like parts throughout the various views of the drawings.

### DETAILED DESCRIPTION OF THE INVENTION

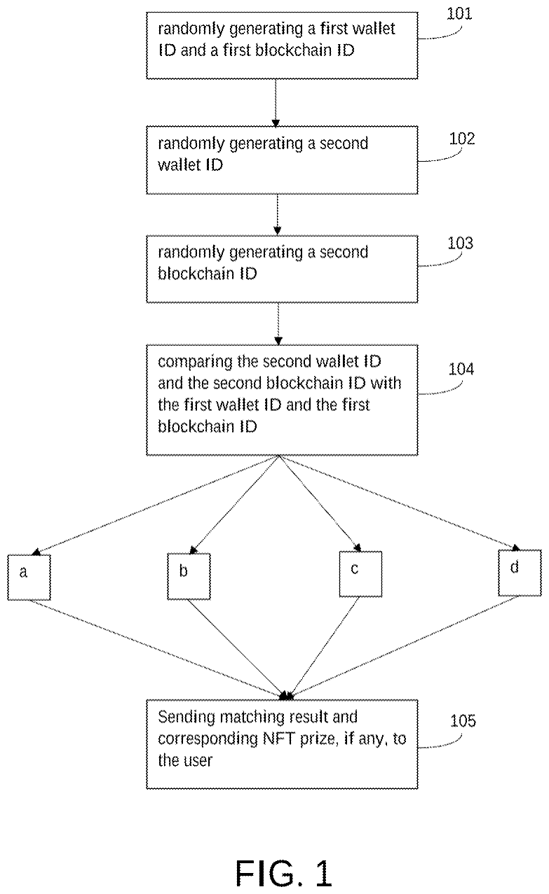

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front.” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

Please refer to FIG. 1, it shows a block diagram of the lottery drawing method for multiple NFT prize. The method comprising the steps listed below.
Step 101: Randomly generating a first wallet ID and a first blockchain ID for a NFT prize game created in a NFT lottery system, wherein the NFT prize game contains three types of the NFT prizes, which are third tier NFT prizes, second tier NFT prizes, and first tier NFT prizes.

In this step, the first wallet ID and the first blockchain ID are stored in a secure database of the NFT lottery system. Therefore, there is no way for others to know what the specific IDs of the prize are, thus protecting the fairness of each player in the lottery game.
Step 102: Randomly generating a second wallet ID when a user creates a crypto wallet in the NFT lottery system.
Step 103: Randomly generating a second blockchain ID when the user uses the crypto wallet to buy a NFT lottery ticket in the NFT lottery system.
Step 104: Comparing the second wallet ID and the second blockchain ID with the first wallet ID and the first blockchain ID, then there will be four different results. They are listed as, “a” result, “b” result, “c” result, and “d” result below.
   (a) if the second wallet ID matches with last digit or letter of the first wallet ID, and the second blockchain ID matches with last digit or letter of the first blockchain ID, the user wins one of the third tier NFT prizes; or
   (b) if the second wallet ID matches with last two digits or letters of the first wallet ID, and the second blockchain ID matches with last two digits or letters of the first blockchain ID, the user wins one of the second tier NFT prizes; or
   (c) if the second wallet ID matches with last three digits or letters of the first wallet ID, and the second blockchain ID matches with last two digits or letters of the first blockchain ID, the user wins one of the first tier NFT prizes; or
   (d) if the second wallet ID doesn't match with last digit or letter of the first wallet ID, or the second blockchain ID doesn't match with last digit or letter of the first blockchain ID, the user wins nothing.
Step 105: Sending matching result and corresponding NFT prize, if any, to the user. For example, if the result is d, a message is sent and displayed to inform the user of such outcome, and no prize will be sent to the user.

In this embodiment, the present invention further comprising a step to confirm the match results after Step 104 to double-check whether the winning result is correct. When the result is confirmed, it will move on to step 105.

In some embodiments, each possible tier prize will have a corresponding NFT design. For example, the first tier NFT prize could have a similar base logo with gold colors. These additional designed are stored until the match has been verified. Once the system has verified a match, the user will be presented with the corresponding design.

Through the above-mentioned special matching method and the lottery drawing method that utilizes full digitization, the user can quickly and simply carry out the lottery game, and because the prizes are all carried out in the form of NFTs, the prizes that each winner receives are unique. This also increases the player's motivation to participate and the sense of accomplishment after receiving the prize. In addition, when the ticket of the NFT lottery game is purchased, the user's wallet ID and email are securely saved and encrypted. Not only does this allow for a way to contact winning matches, as it also allows for a periodic selection of winners to be selected from our database in raffle style.

In another aspect, this invention also discloses a NFT lottery system 1, which uses a lottery drawing method mentioned above. The system 1 comprising:
an ID generator 11, for randomly generating a first wallet ID, a first blockchain ID for an NFT prize game created in the NFT lottery system, and a second wallet ID and a second blockchain ID, wherein the NFT prize game contains three types of the NFT prizes, which are third tier NFT prizes, second tier NFT prizes, and first tier NFT prizes;
a comparing processor 12, which is connected to the ID generator 11 for comparing the second wallet ID and the second blockchain ID with the first wallet ID and the first blockchain ID, wherein:
   (a) if the second wallet ID matches with last digit or letter of the first wallet ID, and the second blockchain ID matches with last digit or letter of the first blockchain ID, the user wins one of the third tier NFT prizes; or
   (b) if the second wallet ID matches with last two digits or letters of the first wallet ID, and the second blockchain ID matches with last two digits or letters of the first blockchain ID, the user wins one of the second tier NFT prizes; or
   (c) if the second wallet ID matches with last three digits or letters of the first wallet ID, and the second blockchain ID matches with last two digits or letters of the first blockchain ID, the user wins one of the first tier NFT prizes; or
   (d) if the second wallet ID doesn't match with last digit or letter of the first wallet ID, or the second blockchain ID doesn't match with last digit or letter of the first blockchain ID, the user wins nothing; and
a notifying processor 13, which is connected to the comparing processor 12 for informing the user whether there is a win and what NFT prize is won.

In the embodiments, the first wallet ID and the second wallet ID have 40 digits respectively and begin with “0x,” and the first blockchain ID and the second blockchain ID have 8 digits respectively.

In some embodiments, each tier of the NFT prizes have different value. For example, the third tier NFT prizes are NFT branded clothing, the second tier NFT prizes are luxury brand merchandise, like watches, and the first tier NFT prizes contain vacations, celebrity meet-ups, luxury cars and/or houses. Since the value is different, the odds are also different. For example, the odd of winning the third tier NFT prizes is between 1/340 and 1/11,560, and preferred odd is 1/340: the odd of winning the second tier NFT prizes is between 1/115,600 and 1/3,930,400, and preferred odd is 1/115,600; the odd of winning the first tier NFT prizes is between 1/11,560,000 to 1/13,363,360,000, and preferred odd is 1/11,560,000. In this way, the NFT prize value of each tier can be matched by reducing the chance of winning.

In some embodiments, the notifying processor 13 will inform both the user and an employee of the NFT lottery system 1 of a winning match, so that the employee could also trace the winning record. Compared to traditional lottery, users of the NFT lottery have the ability to maintain privacy from the general public by simply disclosing as little information on their winnings as they like.

In other embodiments, any past owners of an NFT prize will be added to a royalty pool on the NFT prize they owned. Essentially, they will earn a small amount from each sale following their own. Right now, the system 1 is to cap this royalty pool at a shared 2.5%, meaning as an individual NFT prize accumulates more previous owners, the amount paid to each user will decrease with a total amount paid equaling 2.5% of each sale. This will be automated through the tracking of wallet IDs and emails in which the system already uses, and implemented through a process known as “smart contracts”.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A lottery drawing method for multiple NFT prizes, comprising:
(A) randomly generating a first wallet ID and a first blockchain ID for a NFT prize game created in an NFT lottery system, wherein the NFT prize game contains at least one type of the NFT prizes, which is first tier NFT prizes;
(B) randomly generating a second wallet ID when a user creates a crypto wallet in the NFT lottery system;
(C) randomly generating a second blockchain ID when the user uses the crypto wallet to buy a NFT lottery ticket in the NFT lottery system;
(D) comparing the second wallet ID and the second blockchain ID with the first wallet IDs and the first blockchain IDs, then:
(a) if the second wallet ID matches with last three digits or letters of the first wallet ID, and the second blockchain ID matches with last two digits or letters of the first blockchain ID, the user wins one of the first tier NFT prizes; or
(b) if the second wallet ID doesn't match with last digit or letter of the first wallet ID, or the second blockchain ID doesn't match with last digit or letter of the first blockchain ID, the user wins nothing; and
(E) Sending matching result and corresponding NFT prize, if any, to the user.

2. The method of claim 1, wherein the at least one type of the NFT prizes further comprises second tier NFT prizes and third tier NFT prizes, and the step (D) further comprises:
(c) if the second wallet ID matches with last digit or letter of the first wallet ID, and the second blockchain ID matches with last digit or letter of the first blockchain ID, the user wins one of the third tier NFT prizes; or
(d) if the second wallet ID matches with last two digits or letters of the first wallet ID, and the second blockchain ID matches with last two digits or letters of the first blockchain ID, the user wins one of the second tier NFT prizes.

3. The method of claim 1, wherein the first wallet ID and the second wallet ID have 40 digits respectively and begin with “0x”.

4. The method of claim 3, wherein the first blockchain ID and the second blockchain ID have 8 digits respectively.

5. The method of claim 4, wherein the first wallet ID and the first blockchain ID are stored in a secure database of the NFT lottery system.

6. The method of claim 2, wherein the third tier NFT prizes are NFT branded clothing.

7. The method of claim 6, wherein the second tier NFT prizes are watches and luxury brand merchandise.

8. The method of claim 7, wherein the first tier NFT prizes are at least one of the following: vacations, celebrity meet-ups, luxury cars and houses.

9. The method of claim 8, wherein odd of winning the third tier NFT prizes between 1/340 and 1/11,560.

10. The method of claim 9, wherein odd of winning the second tier NFT prizes is between 1/115,600 and 1/3,930,400.

11. The method of claim 10, wherein odd of winning the first tier NFT prizes is between 1/11,560,000 to 1/13,363,360,000.

12. A NFT lottery system, which uses a lottery drawing method mentioned in claim 1, comprising:
an ID generator, for randomly generating a first wallet ID, a first blockchain ID for an NFT prize game created in the NFT lottery system, and a second wallet ID and a second blockchain ID, wherein the NFT prize game contains at least one type of the NFT prizes, which is first tier NFT prizes;
a comparing processor, which is connected to the ID generator for comparing the second wallet ID and the second blockchain ID with the first wallet ID and the first blockchain ID, wherein:
(a) if the second wallet ID matches with last three digits or letters of the first wallet ID, and the second blockchain ID matches with last two digits or letters of the first blockchain ID, the user wins one of the first tier NFT prizes; or
(b) if the second wallet ID doesn't match with last digit or letter of the first wallet ID, or the second blockchain ID doesn't match with last digit or letter of the first blockchain ID, the user wins nothing; and
a notifying processor, which is connected to the comparing processor for informing the user whether there is a win and what NFT prize is won.

13. The system of claim 12, wherein the at least one type of the NFT prizes further comprises second tier NFT prizes and third tier NFT prizes, and the comparing processor further proceeds with:
(c) if the second wallet ID matches with last digit or letter of the first wallet ID, and the second blockchain ID matches with last digit or letter of the first blockchain ID, the user wins one of the third tier NFT prizes; or
(d) if the second wallet ID matches with last two digits or letters of the first wallet ID, and the second blockchain ID matches with last two digits or letters of the first blockchain ID, the user wins one of the second tier NFT prizes.

14. The system of claim 12, wherein the first wallet ID and the second wallet ID have 40 digits respectively and begin with “0x”.

15. The system of claim 14, wherein the first blockchain ID and the second blockchain ID have 8 digits respectively.

16. The system of claim 15, wherein the first wallet ID and the first blockchain ID are stored in a secure database of the NFT lottery system.

17. The system of claim 13, wherein odd of winning the third tier NFT prizes is between 1/340 and 1/11,560.

18. The system of claim 17, wherein odd of winning the second tier NFT prizes is between 1/115,600 and 1/3,930,400.

19. The system of claim 18, wherein odd of winning the first tier NFT prizes is between 1/11,560,000 to 1/13,363,360,000.
